(19) United States
(12) Patent Application Publication
(10) Pub. No.: US 2012/0066640 A1
(43) Pub. Date: Mar. 15, 2012

(54) APPARATUS FOR PROVIDING MULTI-MODE WARPING OF GRAPHICAL USER INTERFACE OBJECTS

(75) Inventors: Lawrence S. Kwak, Richmond Hill (CA); Piranavan Selvanandan, Toronto (CA)

(73) Assignee: ATI TECHNOLOGIES ULC, Markham (CA)

(21) Appl. No.: 12/880,648

(22) Filed: Sep. 13, 2010

(51) Int. Cl. G06F 3/048

(52) U.S. Cl. 715/788

(57) ABSTRACT

Apparatus provides for providing multi-mode warping of graphical user interface (GUI) objects, such as but not limited to a pointing object (e.g., cursor) and a window. In one example, the apparatus includes logic operative to provide a user interface that allows a user to select different warping modes. In one example, a user may select a pointing object warping mode and/or a window warping mode. In the pointing object warping mode, the apparatus applies a warp operation to one or more pointing objects that uses display content information to determine where to move the pointing object. In the window warping mode, the apparatus applies a warp operation to one or more windows that also uses display content information to determine where to move the window. The destination position of the GUI object is determined based on content identification information associated with display content such as name, serial number or label that identifies the display content.

### CROSS-REFERENCE TO RELATED APPLICATION

This application is related to co-pending application having docket number 00100.10.0023, filed on even date, having inventors Lawrence Kwak et al., titled “METHOD AND APPARATUS FOR CONTROLLING MOVEMENT OF GRAPHICAL USER INTERFACE OBJECTS”, owned by instant assignee.

### BACKGROUND OF THE DISCLOSURE

The disclosure relates generally to apparatus for providing multi-mode warping of graphical user interface objects.

In computer systems having a graphical user interface (GUI) environment, one of the most frequently used human-computer interactions is controlling the movement of one or more GUI objects, such as pointing objects (e.g., cursor), windows, and icons, on a display surface using input devices (e.g., computer mouse, trackball, touchpad, digitizing tablet, etc.). The user controls movement of the GUI object on the display surface by performing actions (gestures, e.g., drag, point, click, etc.) via the input device. Usually, the moving distance of the GUI object on the display surface is linearly proportional to the degree of the user's action applied to the input device. That is, the greater the GUI object moves on the display surface, the greater the input device has to be moved or the equivalent gesture has to be performed. Accordingly, with a high resolution and/or large display size, which may be a single high resolution and/or large size display, an extended desktop of multiple displays, or a single large surface spanning across multiple displays, navigating a GUI object with required precision for granular control requires a potentially long and unproductive input device movement if the distance from the start position to the destination position is large. To compensate, user can increase the GUI object movement speed or acceleration, which unavoidably reduces the accuracy of tracking the GUI object to the desired location.

Some known techniques attempt to solve the above-noted problems by applying a “warp” operation to the GUI object. The warp operation may be an immediate relocation of a GUI object to a destination position without any user intervention during the relocation. In other words, the continuous user action applied to the input device is not necessary for the warp operation during the relocation of the GUI object.

In one example, a command-line utility called “Xwarppointer” available for the Linux operating system can apply the warp operation to a cursor. However, in order to perform the warp operation, user has to input X and Y coordinate to specify the destination position, which introduces a great inconvenience and is not user-friendly.

Multi-Monitor Mouse (M³) is a computer program that allows user to apply the warp operation to a cursor across multiple virtual frames. Instead of specifying the destination position by the X and Y coordinates, M³ provides limited predefined destination position modes, i.e., frame relative, center, and location memory, as options for the user to select. For example, at center mode, the cursor is always warped to the center of a virtual frame. However, none of the predefined destination position modes in M³ is determined based on particular display content (e.g., windows, taskbars, sidebars, docks, program launchers, icons, controls, background also called wallpaper, etc.). Moreover, M³ reads operating system (OS) information about the size, number, and relative location of OS visible display surfaces and forms a corresponding set of virtual frames to represent the OS visible display surfaces. Accordingly, the cursor in M³ can only be cycled through each one of the virtual frames following a sequence specified by the user prior to applying the warp operation. When the system has a single OS visible display surface spanning across multiple displays known as, for example, a “single large surface” (SLS), M³ cannot recognize the multiple displays used to display the SLS and thus, is not applicable to the SLS display mode (also known as the span mode or stretch mode).

The Xwarppointer utility and M³ program can only be applied to pointing objects such as the cursor. As to window warping, some known techniques move the focused window to a left or right adjacent display surface by applying a basic window warp operation. However, the destination position of the focused window on the adjacent display surface is always kept at the same relative position as on the origin display surface, and the size of the focused window cannot be adjusted during the movement.

HydraVision™, a multi-monitor management software, can maximize application windows to different areas of the display surface (desktop) via keyboard shortcuts consisting of one more modifier keys (e.g., CTRL, ALT, SHIFT) and the Maximize button on the application window. For each desktop area, a key combination can be assigned, and the user can maximize a window to that area by clicking the window's Maximize button while holding down the keys assigned to that area. In HydraVision™, the window may be maximized to the entire single OS visible display surface (desktop) spanning across multiple displays (e.g., SLS) or to one or more display(s). Again, none of the known techniques determines the destination position and destination size of a window warp operation based on particular display content of the display surface.

Accordingly, there exists a need for improved apparatus for providing multi-mode warping of GUI objects in order to address one or more of the above-noted drawbacks.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of an apparatus for controlling movement of GUI objects in accordance with one embodiment set forth in the disclosure;

FIG. 2 is a block diagram illustrating the apparatus for controlling movement of GUI objects shown in FIG. 1;

FIG. 3 is a flowchart illustrating one example of a method for controlling movement of GUI objects in accordance with one embodiment set forth in the disclosure;

FIG. 4 is a flowchart illustrating another example of the method for controlling movement of GUI objects;

FIG. 5 is a flowchart illustrating still another example of the method for controlling movement of GUI objects;

FIGS. 6-12 are exemplary illustrations of controlling movement of GUI objects;

FIG. 13 is an illustration of one example of a display content based warp user interface of an apparatus for providing multi-mode warping of GUI objects in accordance with one embodiment set forth in the disclosure; and

FIG. 14 is an illustration of another example of a display content based warp user interface of an apparatus for providing multi-mode warping of GUI objects.

### DETAILED DESCRIPTION OF THE PREFERRED EMBODIMENTS

Briefly, in one example, apparatus for providing multi-mode warping of graphical user interface (GUI) objects (e.g., cursor, window) includes logic operative to provide a user interface that allows a user to select different warping modes. In one example, a user may select a pointing object (e.g., cursor) warping mode and/or a window warping mode. In the pointing object warping mode, the apparatus applies a warp operation to one or more pointing objects that uses display content information to determine where to move the pointing object. In the window warping mode, the apparatus applies a warp operation to one or more windows that also uses display content information to determine where to move the window. The destination position of the GUI object is determined based on content identification information associated with display content such as name, serial number or label that identifies the display content. The display content may be any visible object to be displayed on the display screen, including but is not limited to, windows, taskbars, sidebars, docks, program launchers, icons, controls, and background (wallpaper). The warp operation may be an immediate relocation of the GUI object to the destination position without any user intervention during the relocation.

Among other advantages, for example, the apparatus provides the ability to quickly move one or more GUI objects to a desired location across multiple displays or within a single high resolution and/or large size display with fewer user interactions and higher movement precision. Instead of specifying X and Y coordinate of the destination position or following a limited number of predefined destination positions, user can select the destination position of the GUI object based on particular display content, which is more intuitive and user-friendly, thereby improving user experience in the GUI environment.

In one embodiment set forth in the disclosure, the user interface provides configuration information for the warp operation via a plurality of selection data. The configuration information includes but is not limited to the warping mode (i.e., the types of the GUI object to be warped), the action that triggers the warp operation, and the desired display content. The apparatus then affects the warp operation based on the configuration information provided from the user interface. The user selection data may be presented to the user in the form of GUI elements, such as but not limited to menus (e.g., standard menus, drop-down menus, tree-icon menus), dialog boxes, buttons, scroll bars, icons, property sheets, toolbars, wizards or any suitable GUI element.

In one example, the user interface includes warping mode selection data that allows the user to select the warping mode from at least the pointing object warping mode and the window warping mode. The user interface also includes display content selection data that allows the user to select desired display content for determining the destination position of the GUI object.

In another example, the user interface may include action selection data that allows the user to select the action that triggers the warp operation. If more than one display is employed, the user interface may also include destination display selection data that allows the user to select the destination display from the plurality of displays to help determining the destination position of the GUI object. In the window warping mode, the user interface may further include destination size selection data that allows the user to select the destination size of the window. The apparatus may adjust the size of the window to the selected destination size on the destination position during the warp operation. The destination size of the window may be, for example, the same as its origin size, a maximized window size or a minimized window size.

In another example embodiment set forth in the disclosure, the apparatus also includes an input device operative to receive the action that triggers the warp operation. The apparatus determines the warp operation corresponding to the received action based on the configuration information provided by the user interface. In addition to receiving the configuration information from the user interface, the apparatus may further receive supplemental configuration information for the warp operation when receiving the action. For example, if the desired display content is selected as an open window in the configuration information at the configuration stage, the supplemental configuration information may further indicate that which one of the plurality of open windows is the desired open window. If the supplemental configuration information is received, the apparatus determines the warp operation corresponding to the received action based on both the configuration information and the supplemental configuration information.

In one example, the display content is part of single large surface that is generated by one or more graphical processors in a frame buffer. The single large surface spans across a plurality of displays including at least a first display and a second display. The start position of the GUI object is for a position displayed on the first display, and the destination position of the GUI object is for a position displayed on the second display. Optionally, in this example, the apparatus determines a destination display from the plurality of displays used to display the single large surface to determine the destination position. The destination display, for example, is selected by the user and specified in the configuration information or the supplemental configuration information.

In another example, in the window warping mode, the apparatus determines the destination position and a destination size of the window based on obtained content attribute information associated with the display content. For example, the display content is one or more open windows, and the content attribute information includes window size and window location. The apparatus then controls adjustment of the size of the window to the determined destination size on the destination position during the warp operation. The destination size of the window may be, for example, the same as its origin size, a maximized window size, a minimized window size or a size that fits a void area without any display content.

Also among other advantages, the apparatus can obtain information associated with the display content directly from the display content based warp driver in addition to the operating system (OS) and thus, can be applied to display modes that involve “OS invisible” displays such as the single large surface (SLS) display mode (also known as the span mode or stretch mode). Moreover, as a generic approach, the apparatus performs warp operation on pointing objects, window or any other suitable GUI object or combination thereof. Accordingly, the proposed techniques can improve user experience in GUI environment by providing a more intuitive and user-friendly way to control movement of different GUI objects in various display modes. Other advantages will be recognized by those of ordinary skill in the art.

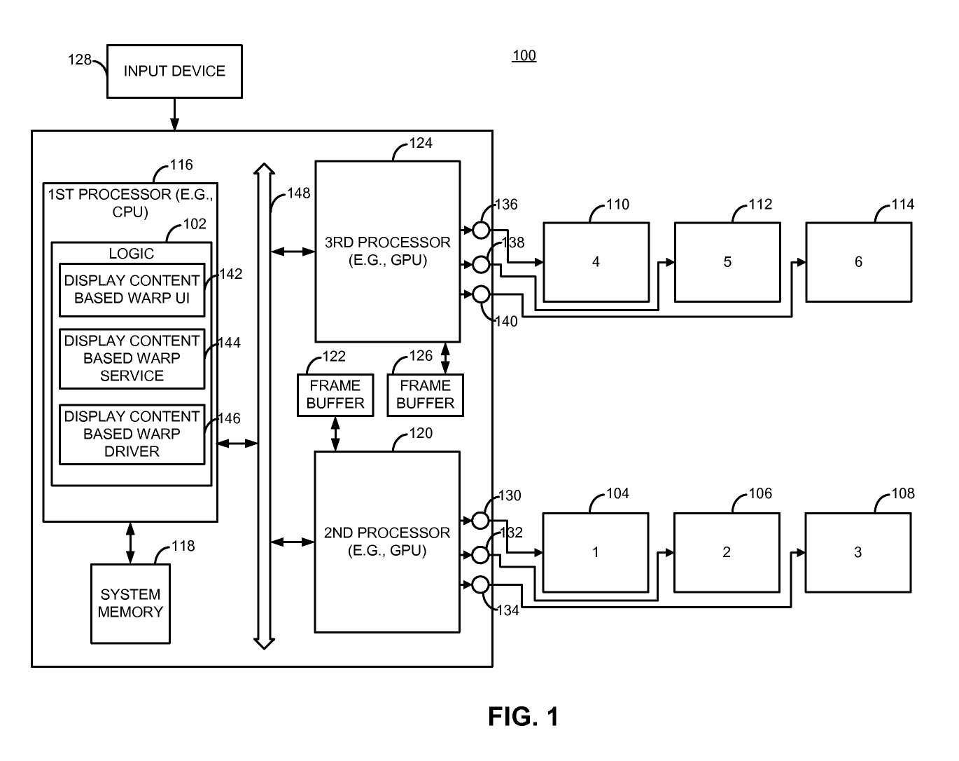

FIG. 1 illustrates one example of an apparatus 100 for controlling movement of GUI objects. The apparatus 100 may be any suitable device, for example, a laptop computer, desktop computer, media center, handheld device (e.g., mobile or smart phone, tablet, etc.), Blu-ray™ player, gaming console, set top box, printer or any other suitable device, to name a few. In this example, the apparatus 100 employs one or more displays 104, 106, 108, 110, 112, 114, a first processor 116 operatively connected to a system memory 118, a second processor 120 operatively connected to a frame buffer 122, and a third processor 124 operatively connected to a frame buffer 126, and data buses or point-to-point connections, such as a system bus 148, which transfer data between each structure of the apparatus 100. The apparatus 100 may also include input device 128, such as a computer mouse, trackball, touchpad, digitizing tablet, touchscreen, joystick, pointing stick, keypad, keyboard, camera, remote controller or any other suitable device. Any other suitable structure, such as but not limited to a storage device or a controller, may also be included in the apparatus 100.

In this example, the first processor 116 is a host central processing unit (CPU) bi-directionally connected to the system memory 118 and bi-directionally connected to other components of the apparatus 100 via the system bus 148 as known in the art, or any other suitable processor. The second and third processors 120, 124 may be graphic processing units (GPUs), each driving one or more displays 104, 106, 108, 110, 112, 114 via the display connectors 130, 132, 134, 136, 138, 140, respectively. In another example, the apparatus 100 may only have one GPU that drives one or more displays. Nevertheless, it is understood that the number of the displays that each processor drives may be varied, and that the type of GPU (e.g., discrete GPU, integrated GPU) may also be varied. It is also understood that, the first, second, and third processors 116, 120, 124 may be integrated as a general processor (e.g., APU, accelerated processing unit; GPGPU, general-purpose computing on GPU); or the first processor (e.g., CPU) 116 may be integrated with the second processor 120 or with the third processor 124 to form a general processor. Although the system memory 118 and the frame buffers 122, 126 are shown in FIG. 1 as discrete memory devices, it is understood that a unified memory architecture that can accommodate all the processors may also be employed.

In this example, the apparatus 100 further includes a plurality of display connectors 130, 132, 134, 136, 138, 140, such as analog display connectors, for example, composite video, S-Video, VGA, digital display connectors, for example, HDMI, mini-DVI, micro-DVI, wireless connectors or any other suitable connectors. The apparatus 100 may include or operatively connect to the displays 104, 106, 108, 110, 112, 114 via the display connectors 130, 132, 134, 136, 138, 140, respectively. One or more display connectors 130, 132, 134, 136, 138, 140 may be internal to the apparatus 100, and one or more displays 104, 106, 108, 110, 112, 114 may form a part of the apparatus 100—e.g., a display forming part of a laptop computer or mobile device such as, for example, a mobile phone. In other examples, one or more displays 104, 106, 108, 110, 112, 114 may be remote displays that are operatively coupled to the apparatus 100 via networks (e.g., personal area network, local area network, wide area network, etc.) or any suitable wired or wireless connections as known in the art. It is understood that, although only one apparatus 100 is shown in FIG. 1, multiple apparatus may be applied to employ the displays 104, 106, 108, 110, 112, 114.

The displays 104, 106, 108, 110, 112, 114 may be any suitable physical displays known in the art, such as but not limited to liquid crystal displays (LCD), light-emitting diode (LED) displays, organic LED (OLED) displays, cathode ray tube (CRT) displays, plasma displays, projector screens, electroluminescent displays, vacuum fluorescent (VF) displays, laser displays, E-ink displays or any other suitable displays, to name a few. The displays 104, 106, 108, 110, 112, 114 may be arranged in a homogenous manner so that all the displays 104, 106, 108, 110, 112, 114 are the same type. The displays 104, 106, 108, 110, 112, 114 may also be arranged in a heterogeneous manner. For example, the first, second, and third displays 104, 106, 108 may be LCD displays, and the fourth, fifth, and sixth displays 110, 112, 114 may be projector screens.

The second and third processors 120, 124 may generate one or more display surfaces (image frames) in the frame buffers 122, 126 and present them on the displays 104, 106, 108, 110, 112, 114 in various display modes as known in the art. The display modes may include but is not limited to a single display mode, a clone display mode, an extended desktop display mode, and a SLS display mode. In the single display mode, only one display surface is presented on the sole display. In the clone display mode, more than one display shows the same display surface. In the extended desktop display mode, each display has its own display surface presented on its screen, and each display surface is an operating system (OS) level display surface that has its own resolution, color depth, refresh rate or orientation. That is, each display in the extended desktop display mode can be recognized by the OS (visible to the OS). As to the SLS display mode, one or more single OS visible display surfaces may be generated and displayed in this mode. Each one single OS visible display surfaces spans across multiple displays, and each display presents a different area of the single OS visible display. In one example, one single OS visible display surface may span across all the displays 104, 106, 108, 110, 112, 114. In another example, a first single OS visible display surface may span across the first, second, and third displays 104, 106, 108, and a second single OS visible display surface may span across the fourth, fifth, and sixth displays 110, 112, 114. All the displays used to display a single OS visible display surface have the same resolution, color depth, refresh rate, and orientation, and appear to the OS as a single display with a very large display surface. In other words, each individual display that forms the single OS visible display surface cannot be recognized by the OS (invisible to the OS).

In this example, the first processor 116 employs logic 102 having a display content based warp user interface (UI) 142, display content based warp service 144, and display content based warp driver 146 to control movement of GUI objects. The logic 102 referred to herein is any suitable executing software module, hardware, executing firmware or any suitable combination thereof that can perform the desired function, such as programmed processors, discrete logic, for example, state machine, to name a few. It is understood that the logic 102 may be included in the first processor 116 as part of the first processor 116, or a discrete component of the apparatus 100 that can be executed by the first processor 116, such as software programs stored on computer readable storage medium that can be loaded into the apparatus 100 and executed by the CPU 116. The display content based warp UI, service, and driver 142, 144, 146 of the logic 102 may communicate with structures in the apparatus 100 such as but not limited to the input device 128, the system memory 118, and the second and third processors 120, 124. The display content based warp UI, service, and driver 142, 144, 146 of the logic 102 may also communicate with software programs running on the CPU 116, for example, the OS, window manager, windowing system, system database, etc.

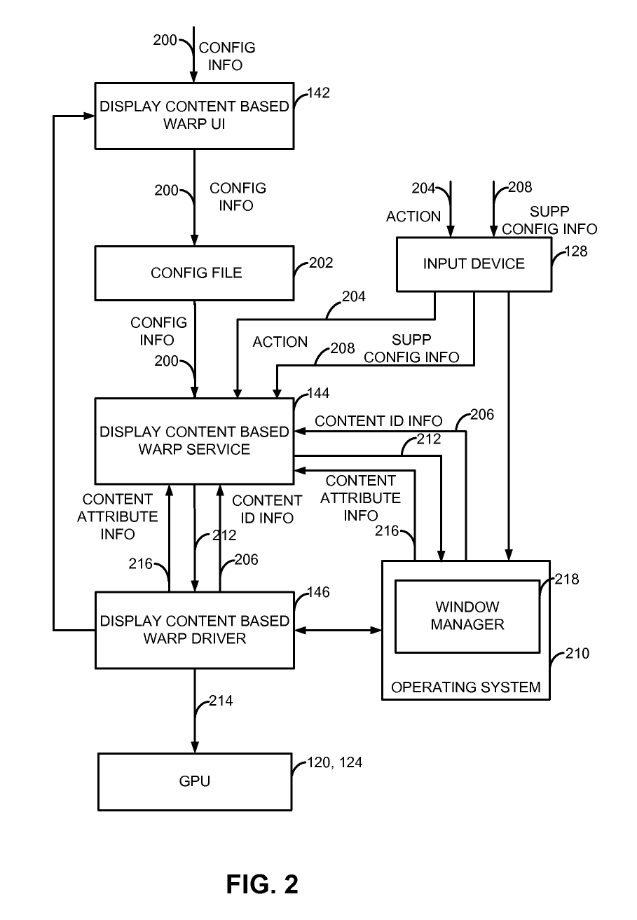

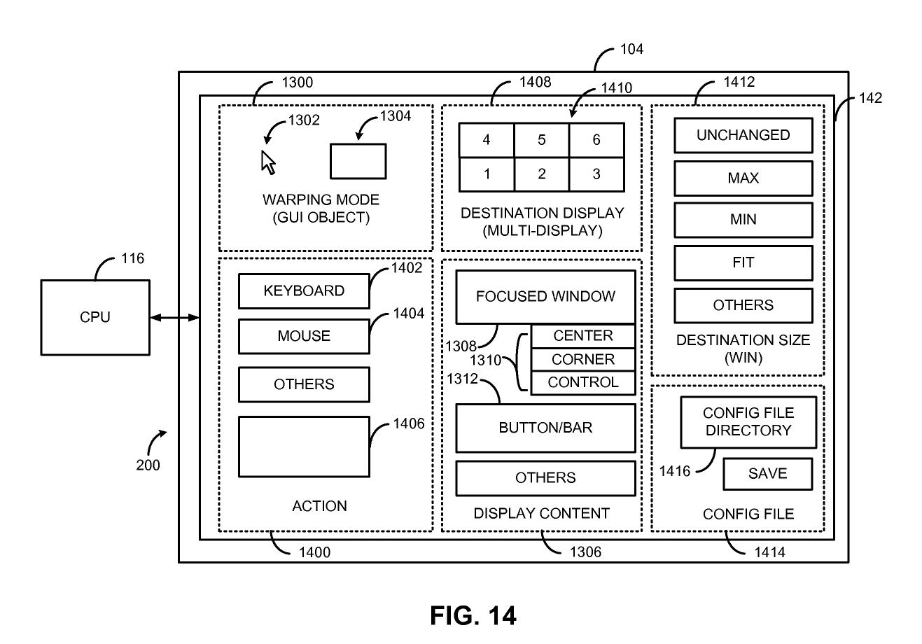

FIG. 2 illustrates one example of an apparatus for controlling movement of GUI objects. The apparatus 100 includes the logic 102 having the display content based warp UI 142, display content based warp service 144, and display content based warp driver 146. In this example, the display content based warp UI 142 may be application software provided by the logic 102 running on the CPU 116. The display content based warp UI 142 is operative to receive configuration information 200 for the display content based warp operation and store the configuration information 200 in a configuration file 202. The display content based warp UI 142 may include multiple selection data. The selection data is presented to the user in the form of GUI elements, such as but not limited to menus (e.g., standard menus, drop-down menus, tree-icon menus), dialog boxes, buttons, scroll bars, icons, property sheets, toolbars, wizards or any suitable GUI element for providing the configuration information 200. Examples of the display content based warp UI 142 are described in detail later referring to FIGS. 13 and 14.

The configuration information 200 includes information for the display content based warp operation, such as but not limited to the warping mode (i.e., the types of the GUI object to be warped), action 204 that triggers the warp display content based warp operation, desired display contents for determining the destination position, destination display from the multiple displays, destination size of a window in the window warping mode, transition effect of the display content based warp operation, and associations thereof. Each type of the configuration information 200 may be provided via selection data of the display content based warp UI 142. For example, the warping mode may be selected from at least a pointing object warping mode and a window warping mode via warping mode selection data of the display content based warp UI 142.

The configuration information 200 includes information regarding the desired display content for determining a destination position. For example, the display content based warp operation may include but is not limited to warping a pointing object to a particular position (e.g., center, corner) with respect to the focused window, warping a pointing object to an active control (e.g., “OK” button) in the focused window, warping a pointing object to the “START” button on the taskbar, warping the focused window so that the center of the focused window is relocated to the center of another open window, and warping the focused window to match a void area without any display content on a display, to name a few. It is understood that the above-mentioned desired display content is presented for the purposes of exemplary and description only and not by limitation. Any suitable warp operation that is based on display content may be appreciated by those having ordinary skill in the art.

Another type of configuration information 200 is information regarding the action 204 that triggers the display content based warp operation. The action 204 may be any suitable human-computer interaction (HCI) known in the art. For example, the action 204 may include physical actions applied to the input device 128 such as pressing or holding, for example, a key or key combination on the keyboard, mouse button or any other peripheral button/key, and input device gesture such as mouse movement or touchpad gestures, to name a few. The action 204 may also include actions of the users themselves such as but not limited to movement of the eyeballs or head and voice commands. The action 204 may be either a single action or multiple actions that are performed in a particular sequence. The sequence of performing the multiple actions may also be provided via action selection data of the display content based warp UI 142 and included in the configuration information 200.

Additionally, the configuration information 200 includes information regarding associations between the above-mentioned various types of information. The display content based warp UI 142, for example, in an interactive manner, first receives the user's selection of a warping mode via warping mode selection data to determine which type of GUI object to be warped. The display content based warp UI 142 then receives, via action selection data, the user's selection of an action 204 that triggers the movement of the GUI object in the selected warping mode. The display content based warp UI 142 further receives the user's selection of the desired display content associated with the selected action 204 and warping mode. Optionally, the display content based warp UI 142 may further receive the user's input regarding additional information (e.g., transition effect) associated with the corresponding action 204, warping mode, and desired display content. In one example, the configuration information 200 indicates that an action 204 of pressing the “CONTROL”, “A”, and “LEFT ARROW” keys on the keyboard triggers an operation of warping the cursor to the center of the focused window on the left adjacent display. In another example, the configuration information 200 indicates that an action 204 of pressing the “ALT”, “A”, “UP ARROW” and “RIGHT ARROW” keys on the keyboard triggers an operation of warping the focused window to match a void area without display content on the upper-right display. Although it is understood that the associations between different types of configuration information 200 may be arbitrary, preferably, an intuitive association may be applied. In one example, the number keys “1-6” on the numeric keypad area of the keyboard are associated with the first to sixth displays 104, 106, 108, 110, 112, 114, respectively. In another example, the “WIN” key on the keyboard is always associated with the selection of the “START” button as the desired display content.

The display content based warp UI 142 may obtain information from the display content based warp driver 146 to facilitate the configuration process. For example, in the SLS display mode, the display content based warp UI 142 may obtain information regarding the number and the physical arrangement (e.g., physical location and relative position) of the displays used to display the single OS visible display surface from the display content based warp driver 146, and present such information to the user as part of the user selection data when the user is configuring the display content based warp operation.

As described above, the configuration information 200, in this example, is stored in the configuration file 202. The configuration file 202 may be a dedicated log file kept in a storage device operatively coupled to the CPU 116, or a database that stores configuration setting and options by the OS 210, such as Windows Registry on the Microsoft Windows® OS.

The logic 102 also includes the display content based warp service 144. The display content based warp service 144 is, for example, provided by the logic 102 running on the CPU 116. The display content based warp service 144 in this example may be a computer program that continuously runs in the background of a multitasking OS 210, rather than under the direct control of a user. The display content based warp service 144 may be initiated as a background process when the OS 210 is booted or may be started manually when required. The display content based warp service 144 may be, for example, a windows service on the Microsoft Windows® OS or a daemon on the UNIX® OS. The display content based warp service 144 is operative to determine a destination position of the GUI object based on content identification information 206 associated with display content. Specifically, the input device 128 receives an action 204 from the user and sends the action 204 to the display content based warp service 144. In one example, when an action 204 is applied to the input device 128, an input interrupt (e.g., a keyboard interrupt) may be captured and identified by the OS 210. The OS 210 then notifies the display content based warp service 144 about the received action 204. In response to the received action 204, the display content based warp service 144 reads the configuration information 200 from the configuration file 202 and determines the display content based warp operation corresponding to the action 204 based on configuration information 200.

Optionally, the display content based warp service 144 may receive supplemental configuration information 208 from the input device 128 in order to determine the display content based warp operation. Being different from the configuration information 200 that is provided prior to taking the action 204, the supplemental configuration information 208 in this example is received along with the action 204 and is associated with the received action 204.

For example, if more than one open window exists, in order to warp the cursor to the center of the focused window, the user may either provide in the configuration information 200 that an action 204 of pressing the “CONTROL” and “A” keys is associated with such warp operation. Or, by an alternative way, the user may provide in the configuration information 200 that an action 204 of pressing the “CONTROL” and “A” keys is associated with an operation of warping the cursor to the center of an open window without specifying the focused window as the desired open window in the configuration information 200; and then the user may select the focused window from the multiple open windows and provide the selection in the supplemental configuration information 208 when taking the action 204. For example, in response to the action 204 of pressing the “CONTROL” and “A” keys, the display content based warp UI 142 may prompt the user for the selection of the desired open window in order to determine the corresponding content based warp operation. The user may then select the focused window as the desired display content by various ways, such as moving the computer mouse to the direction of the focused window or pressing the “SPACE” key on the keyboard, as the supplemental configuration information 208 to be provided to the display content based warp service 144.

Accordingly, for situations that multiple similar display content exists, the user does not have to specify the one particular display content in the configuration information 200, but instead, the user may simply select a group of display content (e.g., open windows) during the configuration stage and decide the particular desired display content (e.g., the focused window) from the group of display content when taking the action 204 to trigger the display content based warp operation, thereby providing flexibility to the user in these situations.

In this example, the display content based warp service 144 is also operative to obtain the content identification information 206 associated with the display content. The content identification information 206 is information that identifies specific display content of the display surface. The display content in this example may be any visible object, as part of the display surface that is generated by the second and/or third processors 120, 124 in the frame buffers 122, 126 and to be displayed on the display screen, such as but not limited to windows, taskbars, sidebars, docks, program launchers, icons, controls, and background (wallpaper). Each one of the display content has it unique content identification information 206 possessed, for example, by the OS 210. The content identification information 206 may be, for example, name, serial number or label (e.g., window handle of a window) stored in metadata associated with the display content. The OS 210 may handle the display content through, for example, window manager 218 and windowing system, which are parts of the OS 210 or operatively coupled to the OS 210. The display content based warp service 144 may obtain such content identification information 206 from the OS 210 after determining the display content based warp operation. For example, if a warp operation is determined as warping the cursor to the “START” button, the display content based warp service 144 then requests the content identification information 206 of the “START” button from the OS 210 and determines the destination position of the cursor to be a relative position (e.g., center) with respect to the “START” button. Because the destination position is determined based on the content identification information 206 of the specific display content (e. g., the center of the “START” button), as opposed to the absolute X and Y coordinate with respect to the display surface, the destination position of the GUI object is maintained at the relative position with respect to the display content even as the display content moves on the display surface.

As noted above, the method and apparatus for controlling movement of GUI objects supports various display modes. If there is only one display employed by the apparatus 100, the display content based warp service 144 determines the destination position of the GUI object based on the content identification information 206 of the display content on the single display. Otherwise, in one example, the display content based warp service 144 may further operative to determine a destination display from the plurality of displays 104, 106, 108, 110, 112, 114. The display content based warp service 144 determines the destination display by analyzing the configuration information 200 and the received action 204. The supplemental configuration information 208 may also be used to determine the destination display if desired.

In one example embodiment, in the case that the plurality of displays 104, 106, 108, 110, 112, 114 are arranged in the extended desktop display mode, the display content based warp service 144 may obtain the content identification information 206 of the display content on the destination display from the OS 210 as all the display 104, 106, 108, 110, 112, 114 are visible to OS in this mode. In another example embodiment, in the case that the plurality of displays 104, 106, 108, 110, 112, 114 are arranged in the SLS display mode, the display content based warp service 144 may obtain the content identification information 206 from both the display content based warp driver 146 and the OS 210. As the displays 104, 106, 108, 110, 112, 114 are invisible to the OS 210 in the SLS display mode, the display content based warp service 144, for example, may bypass the OS 210 and obtain the content identification information 206 of the display content on the destination display from the display content based warp driver 146.

The display content based warp driver 146 is, for example, provided by the logic 102 running on the CPU 116. In this example, the display content based warp driver 146 may be a software program for allowing interaction with the hardware devices, e.g., GPUs 120, 124. The display content based warp driver 146 may include an interface for communication with the GPUs 120, 124 via the system bus 148 and provide commands 214 and/or receive data from the GPUs 120, 124. On the other hand, the display content based warp driver 146 may also have an interface to the OS 210, the display content based warp service 144, and the display content based warp UI 142 to enable, for example, the OS 210, the display content based warp service 144, and the display content based warp UI 142 to interface transparently with the GPUs 120, 124, if desired.

In this example, the display content based warp service 144 is further operative to control movement of one or more GUI objects from a start position to a destination position by applying a display content based warp operation to the GUI object. The display content based warp service 144 may invoke an action call (routine) 212 to the OS 210 and/or the display content warp driver 146 to cause the OS 210 and/or the display content warp driver 146 to apply the display content based warp operation to the GUI object. The action call 212 may also include the information regarding the display content based warp operation, such as but not limited to the type of GUI object to be warped and the destination position of the GUI object. In one example, the Linux OS may apply the display content based warp operation to a cursor by setting the cursor position using the Xwarppointer OS function. In another example, the Microsoft Windows® OS may apply the display content based warp operation to a window by setting the window position using the SetWindowPos OS function. Although it is preferable to apply the display content based warp operation by the OS 210, the display content based warp driver 146 may also be operative to apply the display content based warp operation to the GUI object either alone or with the OS 210 by issuing corresponding commands 214 to the GPUs 120, 124, if desired.

In this example, the display content based warp service 144 may be further operative to control addition of a transition effect to the display content based warp operation during movement of the GUI object. The transition effect is used to indicate the warp operation and help the user to find the destination position after the movement. The transition effects may include but is not limited to dimming origin display (e.g., gamma changes or brightness) and slowly returning it to normal as well as lighting up the destination display (e.g., gamma changes or brightness) and slowly returning it to normal, jiggling the display screen to get the user's attention, GUI object animations or other visual effects, e.g., GUI object trails, and voices indicating the movement to the destination position. Similarly, the transition effects may be added by invoking an action call 212 (routine) of the OS 210 or the display content based warp driver 146 by the display content based warp service 144.

In one example embodiment, the GUI object is a two-dimensional object such as a window. In this example, the display content based warp service 144 is further operative to determine the destination position and a destination size of the window based on content attribute information 216 associated with the display content, and control adjustment of the size of the window to the destination size on the destination position. In this example, the display content may be a window, and the content attribute information 216 includes, for example, window size and window location. Likewise, the display content based warp service 144 may obtain the content attribute information 216 from either the OS 210, the display content based warp driver 146 or both, depending on the current display mode. As the display content in this example is windows, the display content based warp service 144 may obtain the content attribute information 216 of the windows from the window manager 218, which is system software that controls the behavior and appearance of windows within a windowing system in a GUI environment. The display content based warp service 144 is then operative to determine the destination position and the destination size of the windows based on the obtained content attribute information 216.

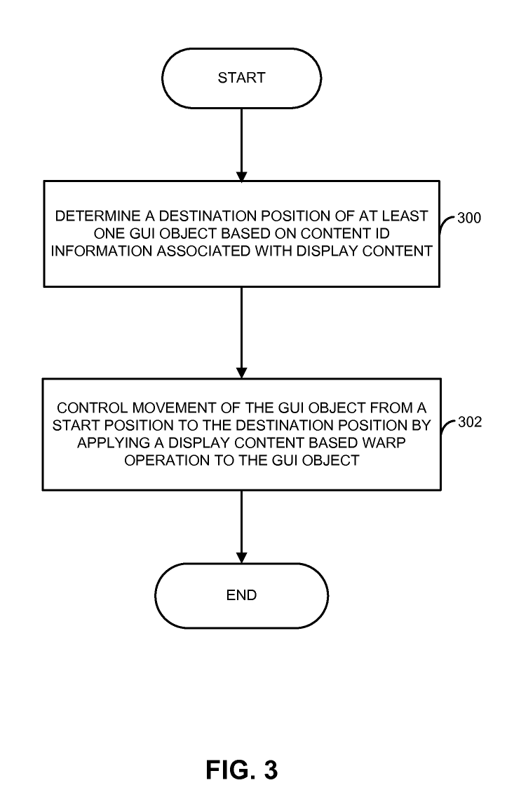

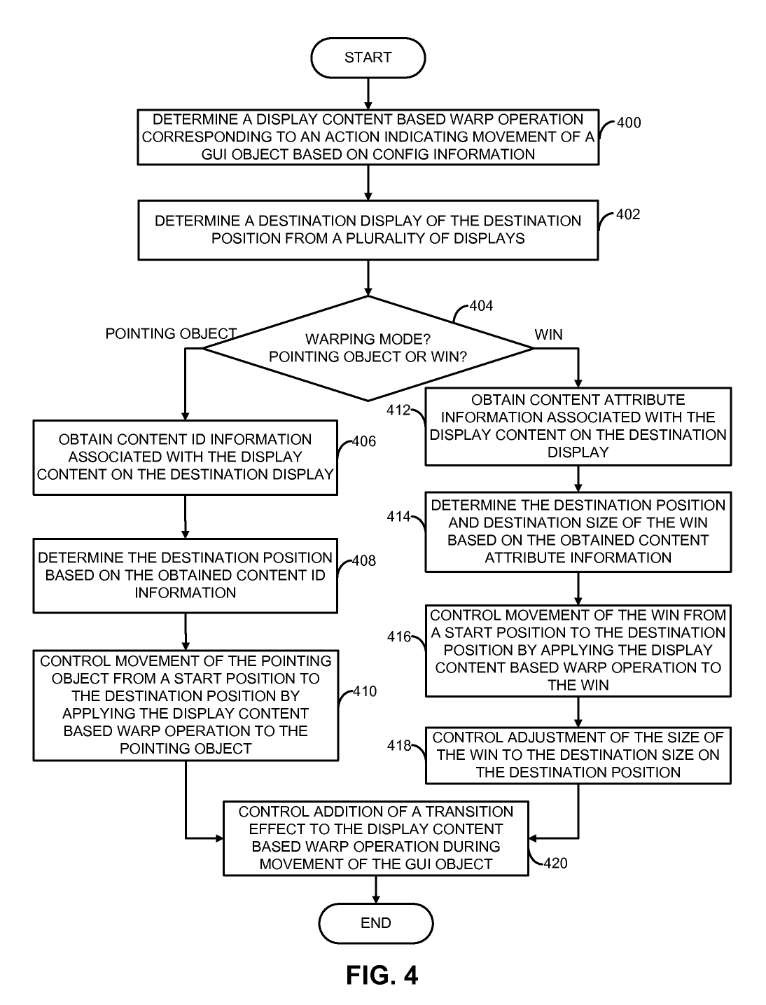

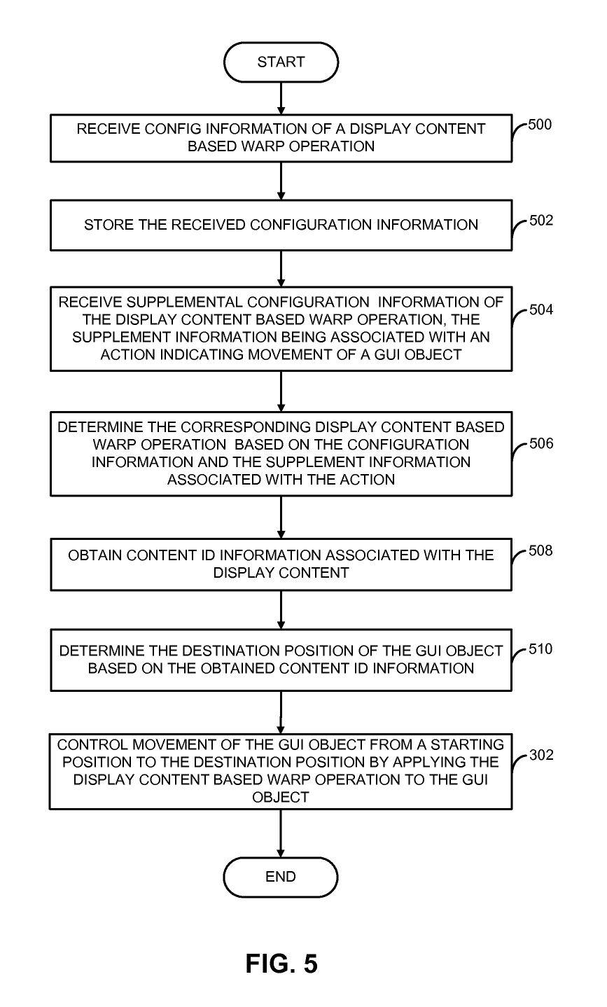

FIG. 3 illustrates one example of a method for controlling movement of GUI objects. It will be described with reference to FIGS. 1 and 2. However, any suitable structure may be employed. In operation, at block 300, the display content based warp service 144 determines a destination position of at least one GUI object based on content identification information 206 associated with display content. At block 302, the display content based warp service 144 then controls movement of the GUI object from a start position to the destination position by causing either the display content based warp driver 146, the OS 210 or both to apply a display content based warp operation to the GUI object. The blocks 300 and 302 are further illustrated in FIGS. 4 and 5.

Referring to FIG. 4, in operation, at block 400, the display content based warp service 144 determines the display content based warp operation corresponding to an action 204 indicating movement of the GUI object based on configuration information 200. The action 204 is received via the input device 128 and is associated with a corresponding display content based warp operation according to the configuration information 200 stored in the configuration file 202. At block 402, if the display mode involves multiple displays 104, 106, 108, 110, 112, 114, the display content based warp service 144 may determine a destination display of the destination position from the multiple displays 104, 106, 108, 110, 112, 114. In the SLS display mode, the display content based warp service 144 determines the destination display via the display content based warp driver 146 that can recognize OS invisible display in this mode. Proceeding to block 404, the display content based warp service 144 in this example recognizes whether the display content based warp operation is applied to a pointing object or a window.

In one embodiment in accordance with the disclosure, if the display content based warp service 144 recognizes that the received action 204 indicates selection of a pointing object warping mode for controlling movement of a pointing object, or if the configuration information 200 indicates that the warping mode has been set to the pointing object warping mode by the user at the configuration stage, the processing proceeds to block 406. At block 406, the display content based warp service 144 obtains the content identification information 206 associated with the display content on the destination display from either the display content based warp driver 146, the OS 210 or both depending on the current display mode. At block 408, the display content based warp service 144 determines the destination position based on the obtained content identification information 206 associated with the display content. Preferably, the destination position is determined as a relative position with respect to the specific display content, as opposed to the absolute X and Y coordinate with respect to the display surface. For example, the destination position may be determined as a position having a zero-offset with respect to the center of the desired display content, or a position having a constant offset relative to any fixed position of the desired display content according to the configuration information 200.

At block 410, the display content based warp service 144 controls movement of the pointing object from a start position to the destination position by causing the OS 210 to apply the display content based warp operation to the pointing object. The display content based warp operation and the destination position are determined at blocks 400 and 408, respectively, by the display content based warp service 144.

Returning back to block 404, in one embodiment in accordance with the disclosure, if the display content based warp service 144 recognizes that the received action 204 indicates selection of a window warping mode for controlling movement of a window, or if the configuration information 200 indicates that the warping mode has been set to the window warping mode by the user at the configuration stage, the processing then proceeds to block 412. The window to be warped is preferably the focused window. It is understood that in other examples, the window may be any two-dimensional GUI object with changeable size and is not limited to the focused window. In addition to the content identification information 206, the display content based warp service 144 also obtains content attribute information 216 associated with the display content from either the display content based warp driver 146, the OS 210 or both depending on the current display mode. For example, the content attribute information 216 may include window size and window location that can be obtained from the window manager 218.

At block 414, in this example, the display content based warp service 144 determines the destination position and the destination size of the focused window based on content attribute information 216 obtained at block 412. The relationship and association between the destination position and size of the window and the content attribute information 216 may be provided in the configuration information 200 via the display content based warp UI 142, or may be defined as predetermined rules. For example, if the obtained content attribute information 216 indicates that at least one display content (window) on the destination display is maximized and occupies the entire display surface, the destination position of the GUI object (focused window) is then determined to be a position at the taskbar on the destination display, and the destination size of the GUI object (focused window) is to be a minimized window size.

At block 416, the display content based warp service 144 then controls movement of the focused window from a start position to the destination position by causing the OS 210 to apply the display content based warp operation to the focused window. The display content based warp operation and the destination position and size are determined at blocks 400 and 414, respectively, by the display content based warp service 144. At block 418, the display content based warp service 144 further controls adjustment of the size of the focused window to the destination size on the destination position. For example, the focused window may be warped to the taskbar on the destination display, and its size may be adjusted to the minimized window size. That is, the focused window is minimized to the taskbar on the destination display in this example.

Optionally, at block 420, the display content based warp service 144 may control the OS 210 or the display content based warp driver 146 to add a transition effect to the display content based warp operation during movement of the GUI object to improve the user experience of the display content based warp operation.

Although the processing blocks illustrated in FIG. 4 are illustrated in a particular order, those having ordinary skill in the art will appreciate that the processing can be performed in different orders. In one example, blocks 416 and 418 may be performed essentially simultaneously. The display content based warp service 144 may simultaneously control the movement and the size adjustment of the focused window. In another example, blocks 410 and 420 or blocks 416, 418, and 420 may be performed essentially simultaneously. The display content based warp service 144 may control the addition of the transition effect to the display content based warp operation during the movement of the GUI object.

Referring to FIG. 5, in this example embodiment, the method for controlling movement of GUI objects may include receiving configuration information 200 of the display content based warp operation by the display content based warp UI 142 at block 500. Preferably, the display content based warp UI 142 is a GUI having user selection data, and such processing is performed by the display content based warp UI 142 in an interactive manner with prompts (i.e., user selection data) provided to help the user to configure the display content based warp operation. Other options may be available to the user as well, such as configuring the display content based warp operation by writing a script using a scripting language such as Tcl or Perl and loading the script file to the display content based warp UI 142. Subsequently, at block 502, the received configuration information 200 is stored in the configuration file 202, such as but not limited to a dedicated log file or a system database. It is understood that in other examples, blocks 500 and 502 may be omitted in the processing, and the configuration information 200 may be predefined rules without user's inputs.

In this example embodiment, the configuration information 200 may not include all the information that is necessary to determine the display content based warp operation. Thus, at block 504, the display content based warp service 144 receives supplemental configuration information 208 associated with the action 204 from an input device 128. The supplemental configuration information 208 is provided at a later stage compared with the configuration information 200 to allow the user further configure the display content based warp operation after the initial configuration stage. At block 506, the display content based warp service 144 determines the display content based warp operation corresponding to the action 204 based on both the configuration information 200 and the supplemental configuration information 208 in this example.

The apparatus 100 may be in the single display mode in this example embodiment. At block 508, the display content based warp service 144 obtains content identification information 206 associated with display content from the OS 210. The display content based warp service 144 further determines the destination position of the GUI object based on the content identification information 206 associated with the display content at block 510.

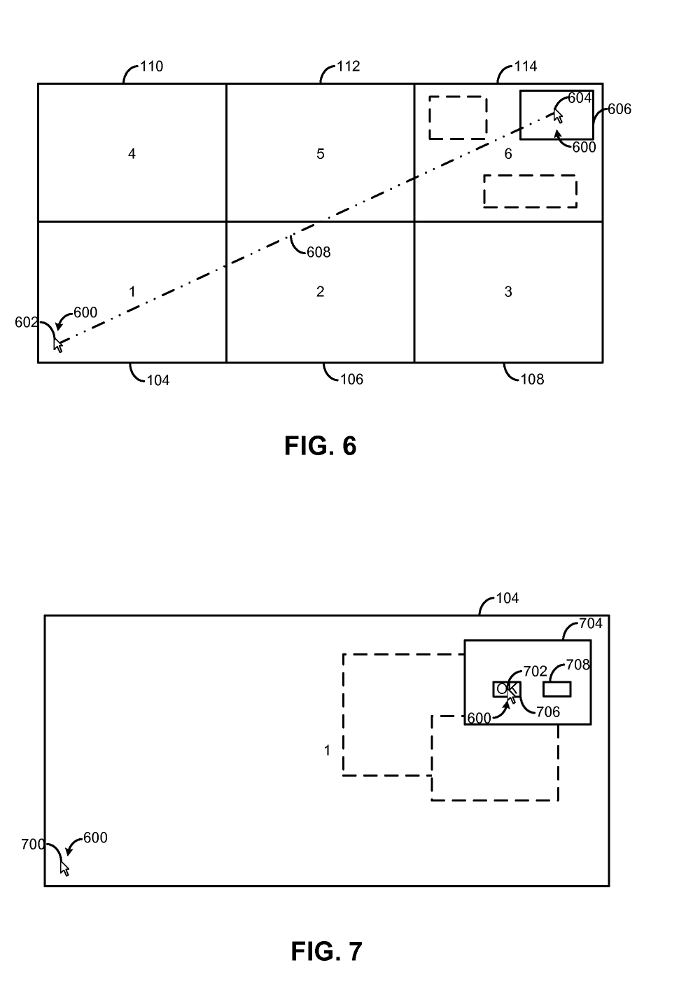

FIGS. 6-12 are illustrations of exemplary embodiments in accordance with the disclosure. FIG. 6 illustrates an example of controlling movement of a cursor 600 from a start position 602 on the origin display (i.e., the first display 104) to a destination position 604 in the SLS display mode. The display content based warp UI 142 provides the configuration information 200 based on user's inputs, which indicates that the display content based warp operation is in the pointing object warping mode, and an action 204 of pressing the “CONTROL” and “A” keys on the keyboard 128 is associated with an operation of warping the cursor 600 from the start position 602 to the center of the focused window 606.

The display content based warp service 144 keeps continuously monitors the action 204 via the input device 128. Once the action 204 of pressing the “CONTROL” and “A keys is performed by the user and received from the keyboard 128 to the display content based warp service 144, the display content based warp service 144 determines that the corresponding warp operation is warping the cursor 600 from the start position 602 to the center of the focused window 606. As the apparatus 100 is in the SLS display mode, from the display content based warp driver 146, the display content based warp service 144 determines that the focused window 606 is on the sixth display 114. The display content based warp service 144 then further obtains the content identification information 206 of the focused window 606 on the sixth display 114 from the display content based warp driver 146 and the OS 210 (window manager 218), and determines the destination position 604 to be the same position as the center of the focused window 606.

Eventually, the display content based warp service 144 controls the cursor 600 to move from the start position 602 on the origin display 104 to the center of the focused window 606 by causing the OS 210 to apply the display content based warp operation to the cursor 600. As shown in FIG. 6, optionally, a transition effect 608, such as a cursor trail, may be added to the display content based warp operation to improve the user experience of the cursor movement.

FIG. 7 illustrates an example of controlling movement of a cursor 600 from a start position 700 on a display (i.e., the first display 104) to a destination position 702 on the same display 104 in the single display mode. The first display 104 may be a large size display, e.g., 24 inch or above, and/or a display operating at a high resolution, e.g., 1920×1080 or above, and thus, the controlling of the cursor movement on this display may be troublesome. In this example, the display content based warp UI 142 provides the configuration information 200 based on user's inputs, which indicates that an action 204 of pressing the “CONTROL” and “B” keys on the keyboard 128 is associated with an operation of warping the cursor 600 from the start position 700 to one of the controls in the focused window. At the configuration stage, the user may specify that the destination position 702 is referenced to the active control (i.e., default keyboard focused control) in the focused window. Alternatively, the user may not specify which control that the destination position 702 should be referenced to if there is more than one control in the focused window. In other examples, the selection of the desired control may be received by the display content based warp service 144 as supplemental configuration information 208 associated with the action 204 when the action 204 is performed.

Once the action 204 of pressing the “CONTROL” and “B” keys is performed by the user and received from the keyboard 128 to the display content based warp service 144, the display content based warp service 144 determines that the corresponding warp operation is warping the cursor 600 from the start position 700 to one of the controls 706, 708 in the focused window 704. As there is more than one control 706, 708 in the focused window 704, the display content based warp service 144 may either determine that the active control—“OK” button 706—is the desired control in the focused window 704 if provided in the configuration information 200; or the display content based warp service 144 may require supplemental configuration information 208 to determine the desired control. The display content based warp service 144, for example, may, via the display content based warp UI 142, prompt the user for supplemental configuration information 208 regarding the desired control in the focused window 704. Alternatively, the user may recognize that more than one control 706, 708 exists in the focused window 704 and thus, further press, for example, the “0” key after pressing the “CONTROL” and “B” keys to indicate that the desired control is the “OK” button 706 in the focused window 704. Such indication is received by the display content based warp service 144 via the input device 128 as the supplemental configuration information 208, and is used to determine the corresponding display content based warp operation in combination with the configuration information 200.

The display content based warp service 144 then obtains the content identification information 206 of the “OK” button 706 in the focused window 704 from the OS 210 (window manager 218), and determines the destination position 702 to be the same position as the center of the “OK” button 706 in the focused window 704.

Eventually, the display content based warp service 144 controls the cursor 600 to move from the start position 700 to the center of the “OK” button 706 in the focused window 704 by causing the OS 210 to apply the display content based warp operation to the cursor 600.

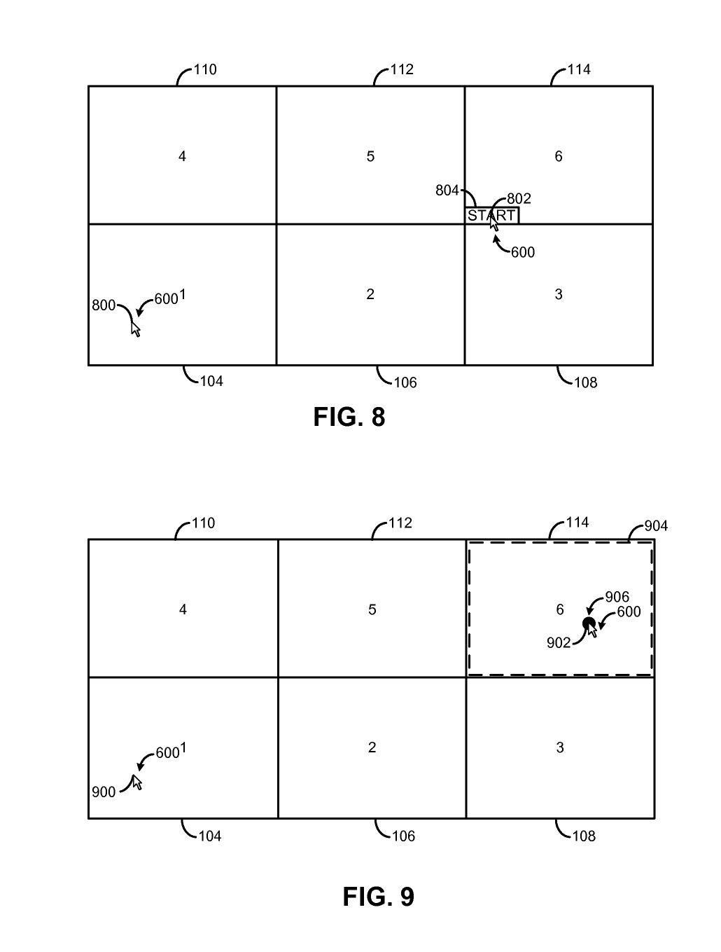

FIG. 8 illustrates an example of controlling movement of a cursor 600 from a start position 800 on the origin display (i.e., the first display 104) to a destination position 802 in the extended desktop display mode. The destination position 802 in this example is the center of the “START” button 804, which is considered as an example of an “optimized-usage-position”. The current cursor position 800 may be far away from the “START” button 804. When the user intends to click the “START” button 804, it is desired to warp the cursor 600 from its current position 800 directly to the “START” button 804.

In this example, the display content based warp UI 142 provides the configuration information 200 based on user's inputs, which indicates that the display content based warp operation is in the pointing object warping mode, and an action 204 of pressing the “CONTROL” and “WIN” keys on the keyboard 128 is associated with an operation of warping the cursor 600 from the start position 800 to the “START” button 804. As there is normally only one “START” button in the extended desktop display mode, the user does not need to provide the destination display in the configuration information 200.

Once the action 204 of pressing the “CONTROL” and “WIN” keys is performed by the user and received from the keyboard 128 to the display content based warp service 144, the display content based warp service 144 determines that the corresponding warp operation is warping the cursor 600 from the start position 800 to the “START” button 804. From the OS 210, the display content based warp service 144 determines that the “START” button 804 is part of the display surface presented on the sixth display 114, and obtains the content identification information 206 of the “START” button 804. The display content based warp service 144 then determines the destination position 802 to be the same as the center position of the “START” button 804.

Eventually, the display content based warp service 144 controls the cursor 600 to move from the start position 800 to the center of the “START” button 804 by causing the OS 210 to apply the display content based warp operation to the cursor 600.

FIG. 9 illustrates an example of controlling movement of a cursor 600 from a start position 900 on the origin display (i.e., the first display 104) to a destination position 902 in the extended desktop display mode. The destination position 902 is referenced to a position or region of interest on a display image such as a background (wallpaper), which is determined based on image analysis. In this example, the position or region of interest is the darkest area of the background on the upper-right display, and the destination position 902 is the center of that darkest area. In other example, the display image may have a human face, and the region of interest may be the left or right eye on the face.

In this example, the display content based warp UI 142 provides the configuration information 200 based on user's inputs, which indicates that the display content based warp operation is in the pointing object warping mode, and an action 204 of pressing the “CONTROL”, “X”, and “6” keys on the keyboard 128 is associated with an operation of warping the cursor 600 from the start position 900 to a position or region of interest on the background of the upper-right display. To determine the position or region of interest on the background, the display content based warp UI 142 may prompt the user for an image analysis condition and/or method. In this example, the user selects an image analysis condition of “the darkest area” from a plurality of options provided by the display content based warp UI 142 at the configuration stage.

Once the action 204 of pressing the “CONTROL”, “X”, and “6” keys is performed by the user and received from the keyboard 128 to the display content based warp service 144, the display content based warp service 144 determines that the corresponding warp operation is warping the cursor 600 from the start position 900 to the center of the darkest area on the background of the upper-right display. From the OS 210, the display content based warp service 144 then obtains the content identification information 206 of the background 904 of the sixth display 114.

In order to determine the destination position 902, the display content based warp service 144 may invoke an action call 212 to control the display content based warp driver 146 to perform an image analysis routine to determine the darkest area on the background 904 of the sixth display 114 as specified in the configuration information 200. The image analysis routine may, for example, include any suitable image filtering algorithm known in the art. In this example, the display content based warp service 144 then further obtains the information regarding the image analysis result from the display content based warp driver 146 and determines the destination position 902 to be the same as the center position of the darkest area 906 on the background 904. In other example, the region of interest may be the left or right eye of a human face on a display image, and any suitable face recognition/detection techniques known in the art may be applied to recognition the eye on the display image in order to determine the destination position. It is understood that if there is more than one position or region of interest identified by the image analysis routine of the display content based warp driver 146, the display content based warp UI 142 may prompt for the user's further selection of the desired position or region of interest on the display image as part of the supplemental configuration information 208.

Eventually, the display content based warp service 144 controls the cursor 600 to move from the start position 900 to the destination position 902 by causing the OS 210 to apply the display content based warp operation to the cursor 600.

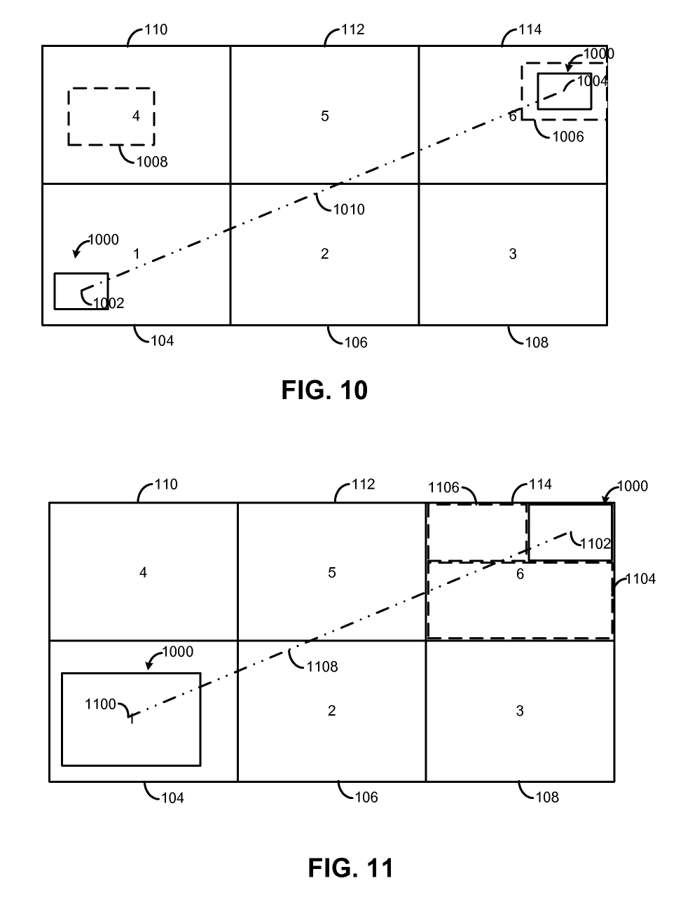

FIGS. 10 and 11 illustrate examples of controlling movement of the focused window 1000 by applying display content based warp operation to the focused window 1000 in the window warping mode. In FIG. 10, the focused window 1000 is moved from a start position 1002 on the origin display (i.e., the first display 104) to a destination position 1004 on top of another open window 1006 in the SLS display mode. In this example, as both the GUI object and the display content are two-dimensional display objects, i.e., windows, the start position 1002 and the destination position 1004 may be defined as the center of each window. It is understood that in other examples, the start position 1002 and the destination position 1004 may be defined as any other position of the windows, for example, the upper-left corner of the windows.

In this example, the display content based warp UI 142 provides the configuration information 200 based on user's inputs, which indicates that that the display content based warp operation is in the window warping mode, and an action 204 of pressing the “ALT” and “B” keys on the keyboard 128 is associated with a warp operation of warping the focused window 1000 on the origin display 104 from the start position 1002 to another open window. The configuration information 200 also provides that the destination size of the focused window 1000 remains the same after the movement.

Once the action 204 of pressing the “ALT” and “B” keys is performed by the user and received from the keyboard 128 to the display content based warp service 144, the display content based warp service 144 determines that the corresponding warp operation is warping the focused window 1000 from the start position 1002 to another open window. If there are multiple open windows exist, supplemental configuration information 208 may be necessary. In this example, to select the desired open window from the two open windows 1006, 1008, the user may, while pressing the “ALT” and “B” keys on keyboard 128, also move the mouse 128 to the upper-right direction to indicate that the desired open window is on the upper-right display, which is, in this example, the open window 1006 on the sixth display 114.

As the apparatus 100 is in the SLS display mode, from the display content based warp driver 146, the display content based warp service 144 determines that the desired open window is the open window 1006 on the sixth display 114. The display content based warp service 144 then further obtains the content identification information 206 of the open window 1006 from the display content based warp driver 146 and the OS 210 (window manager 218), and determines the destination position 1004 to be the same position as the center of the open window 1006.

Eventually, the display content based warp service 144 controls the center of the focused window 1000 to move from the start position 1002 to the center of the open window 1006 by causing the OS 210 to apply the display content based warp operation to the focused window 1000. The display content based warp service 144 also controls the size of the focused window 1000 to remain its origin size after the movement. As shown in FIG. 10, optionally, a transition effect 1010, such as a window movement trail, may be added to the display content based warp operation to improve the user experience of the window warping.

FIG. 11 illustrates an example of controlling movement of a focused window 1000 from a start position 1100 on the origin display (i.e., the first display 104) to a destination position 1102 on the upper-right display in the extended desktop display mode. In this example, the focused window 1000 is moved to a void area without display content on the destination display 114, and its size is adjusted to match the void area.

In this example, the display content based warp UI 142 provides the configuration information 200 based on user's inputs, which indicates that an action 204 of pressing the “ALT”, “A”, “UP ARROW”, and “RIGHT ARROW” keys on the keyboard 128 is associated with an operation of warping the focused window 1000 from the start position 1100 to the void area on the upper-right display and adjusting the size of the focused window 1000 to match the void area.

Once the action 204 of pressing the “ALT”, “A”, “UP ARROW”, and “RIGHT ARROW” keys is performed by the user and received from the keyboard 128 to the display content based warp service 144, the display content based warp service 144 determines the corresponding display content based warp operation based on the configuration information 200 stored in the configuration file 202. From the OS 210, the display content based warp service 144 then determines that the upper-right display (destination display) is the sixth display 114. The display content based warp service 144 then obtains, from the OS 210 (window manager 218), the content identification information 206 of all the display content on the sixth display 114, which are open windows 1104, 1106 in this example. The display content based warp service 144 further obtains the content attribute information 216 of the open windows 1104, 1106, such as window location and window size, from the OS 210 (window manager 218). By analyzing the obtained content attribute information 216, the display content based warp service 144 determines the void area on the sixth display 114, and further determines the destination position 1102 and the destination size of the focused window 1000 so as to match the void area.

Eventually, the display content based warp service 144 controls the focused window 1000 to move its center from the start position 1100 to the center position of the void area by causing the OS 210 to apply the display content based warp operation to the focused window 1000, and also controls the focused window 1000 to adjust its size to match the void area as shown in FIG. 11. Optionally, a transition effect 1108, such as a window movement trail, may be added to the display content based warp operation to improve the user experience of the window movement.

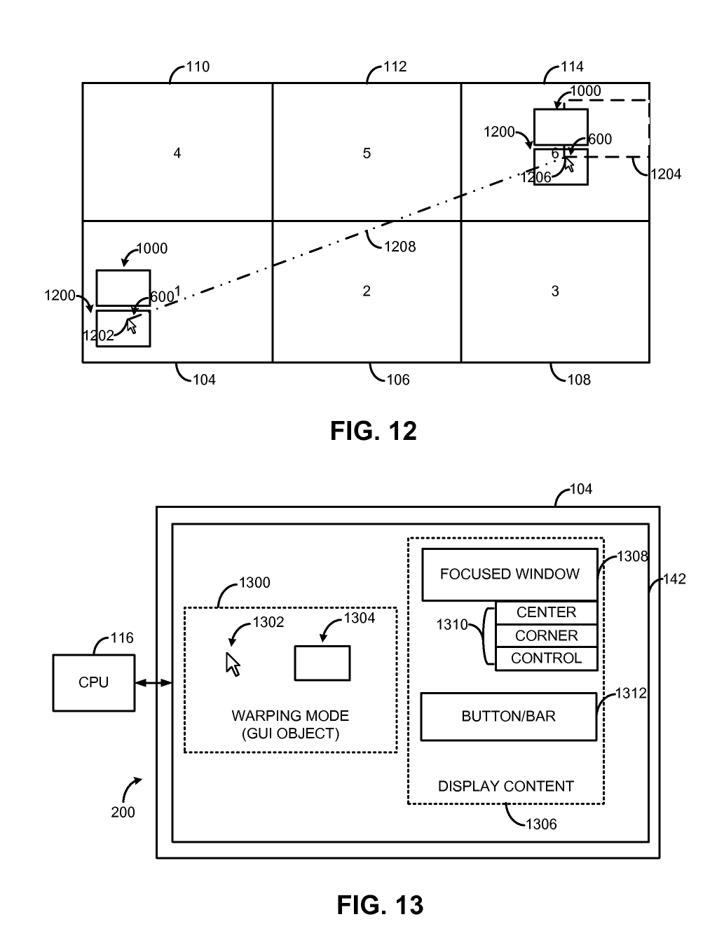

FIGS. 6-11 illustrate examples of controlling movement of a single GUI object. The method and apparatus can essentially simultaneously control movement of multiple GUI objects as well. The multiple GUI objects to be warped may be the same type, such as multiple windows, or may be different types, such as one or more windows and a cursor. FIG. 12 illustrates an example of controlling movement of all open windows 1000, 1200 and a cursor 600 on the origin display (i.e., the first display 104) to the upper-right display in the extended desktop display mode. It may be desired to keep the same relative position of the GUI objects 600, 1000, 1200 before and after the movement.

In this example, the display content based warp UI 142 provides the configuration information 200 based on user's inputs, which indicates that an action 204 of pressing the “SPACE”, “C”, and “6” keys on the keyboard 128 is associated with a display content based warp operation, which warps the cursor 600 from the start position 1202 to the lower-left corner of the focused window 1204 on the upper-right display, and at the same time, warps all the open windows 1000, 1200 on the same display 104 to the destination display while maintaining the relative positions of the open windows 1000, 1200, and the cursor 600.

Once the action 204 of pressing the “SPACE”, “C”, and “6” keys is performed by the user and received from the keyboard 128 to the display content based warp service 144, the display content based warp service 144 determines the corresponding warp operation based on the configuration information 200 stored in the configuration file 202. From the OS 210, the display content based warp service 144 then determines that the upper-right display is the sixth display 114. The display content based warp service 144 then obtains, from the OS 210 (window manager 218), the content identification information 206 of the focused window 1204. Preferably, in multiple GUI objects movement case, a base GUI object is decided by the user or predefined rules to determine the destination position. In this example, the cursor 600 is specified as the base GUI object by the user in the configuration information 200. Accordingly, the display content based warp service 144 determines the destination position 1206 to be the same position as the lower-left corner of the focused window 1204. The display content based warp service 144 also determines the destination positions of the two open windows 1000, 1200 so that the relative positions of the GUI objects 600, 1000, 1200 are kept the same after the movement.

Eventually, the display content based warp service 144 controls the cursor 600 to move from the start position 1202 to the destination position 1206 by applying the display content based warp operation to the cursor 600, and at the same time, also controls the two open windows 1000, 1200 to warp to their destination positions. Optionally, a transition effect 1208, such as a cursor movement trail, may be added to the display content based warp operation to improve the user experience of the movement.

In this example, optionally, the user may further define that an action 204 of holding the “SPACE”, “C”, and “6” keys on the keyboard 128 triggers the above-mentioned display content based warp operation, while another action 204 of releasing the “SPACE”, “C”, and “6” keys triggers a reversed display content based warp operation of warping the GUI objects 600, 1000, 1200 back to their start positions. Accordingly, the display content based warp service 144 may record the start position 1202 before the movement. In response to the action 204 of releasing the “SPACE”, “C”, and “6” keys, the display content based warp service 144 sets the destination position as the recorded start position 1202, and controls the GUI objects 600, 1000, 1200 to be warped back to their start positions.

FIG. 13 illustrates one example of a display content based warp UI 142 of apparatus 100 for providing multi-mode warping of GUI objects. The logic 102 is operative to provide the display content based warp UI 142. In this example, the logic 102 is a software program that when executed by the CPU 116 causes the CPU 116 to present a display content based warp UI 142 on one of the displays 104, 106, 108, 110, 112, 114, e.g., the first display 104. The display content based warp UI 142 is preferably a GUI that contains user selection data. The user selection data may be presented to a user in the form of GUI elements, such as but not limited to menus (e.g., standard menus, drop-down menus, tree-icon menus), dialog boxes, buttons, scroll bars, icons, property sheets, toolbars, wizards or any suitable GUI element. The display content based warp UI 142 may also be a text UI or a command-line UI in other examples.

In this example, the display content based warp UI 142 is presented on the first display 104 to the user, and is used to configure the display content based warp operation by providing the configuration information 200. Each GUI element of the display content based warp UI 142 represents user selection data for the configuration information 200. To improve user experience, the user selection data may be grouped in this example. As shown in FIG. 13, the display content based warp UI 142 includes warping mode selection data 1300 that allows the user to select the warping mode from at least a pointing object warping mode and a window warping mode. For example, the warping mode selection data 1300 includes pointing object warping mode selection data 1302 and window warping mode selection data 1304. When the user selects the pointing object warping mode selection data 1302, the display content based warp UI 142 provides configuration information 200 indicating that the user intends to control movement of the pointing object (e.g., cursor); and when the user selects the window warping mode selection data 1304, the display content based warp UI 142 provides configuration information 200 indicating that the user intends to control movement of a window (e.g., the focused window). It is understood that the selection data 1302, 1304 may be selected together, which indicates that the user intends to control movement of both the pointing object and the window. The warping mode selection data 1300 may include any other suitable selection data for receiving the user's further selections regarding the warping mode. For example, when the window warping mode is selected, and the display content based warp UI 142 obtains information from the OS 210 and/or the display content based driver 146 indicating that more than one window exists, the warping mode selection data 1300 may provide another selection data that allows the user to select the desired one or more windows to be warped from all the existing windows.

The display content based warp UI 142 also includes display content selection data 1306 that allows the user to select the desired display content in order to determine the destination position. In this example, the display content selection data 1320 may include focused window selection data 1308 for selection of the focused window as the desired display content. If the focused window selection data 1308 is selected, another group of destination position selection data 1310 may be provided to help the user to select the destination position with respect to the focused window, such as but not limited to the center, the corner, and the active control of the focused window. The display content selection data 1306 may also include button/bar selection data 1312 representing selection of another type of display content as the desired display content, such as but not limited to the “START” button and taskbar.

All the configuration information 200 received from each selection data of the display content based warp UI 142 is consolidated and saved. The configuration information 200 may be automatically stored in an OS database (e.g., Windows Registry) or a configuration file 202 by the display content based warp UI 142.

FIG. 14 illustrates another example of a display content based warp UI 142 of apparatus 100 for providing multi-mode warping of GUI objects. In addition to the warping mode selection data 1300 and the display content selection data 1306, the display content based warp UI 142 in this example also includes other selection data for configuring the display content based warp operation.

The display content based warp UI 142 may include action selection data 1400 that allows the user to select the action 204 that can trigger the display content based warp operation. In this example, multiple selection data 1402, 1404 are presented to the user, each representing one input device 128 for receiving the action 204. For example, when the user selects the keyboard selection data 1402, another group of selection data, for example, drop-down menus or tree-icon menus may be provided to the user for further selecting a key or key combination that represents the action 204. Additionally or alternative, the action selection data 1400 may provide a text input box 1406 to the user so that the user can type a script using a scripting language such as Tcl or Perl in the text input box 1406 to define the action 204.

The display content based warp UI 142 may further include a destination display selection data 1408. In this example, the display content based warp UI 142 obtains information regarding the number and physical arrangement (e.g., physical location and relative position) of the displays 104, 106, 108, 110, 112, 114 from the display content based warp driver 146 and/or the OS 210. The display content based warp UI 142 then provides displays selection data 1410 to the user, which represents the number and physical arrangement of the displays 104, 106, 108, 110, 112, 114 that are currently employed by the apparatus 100. In one example, as shown in FIG. 14, the displays selection data 1410 presents the displays by enumerating them as number 1 to number 6. In other examples, the displays selection data 1410 may present the displays 104, 106, 108, 110, 112, 114 based on their relative position or direction. That is, the displays selection data 1410 provides selection of various moving direction (e.g., left, top, top-left, etc.) from the origin display to the destination display for the user. In one example of this case, the user may select the destination display as whatever adjacent display that exists on the left of the origin display. Via the displays selection data 1410, the user selects the destination display from the plurality of displays 104, 106, 108, 110, 112, 114.

If only one display is employed by the apparatus 100, for example, in the single display mode, the destination display selection data 1408 may be unselectable for the user. Alternatively, instead of providing the destination display selection data 1408, the display content based warp UI 142 may provide another selection data for selection of a destination logic region of the display surface. The multiple logic regions of the display surface may be predefined, and the display content based warp UI 142 may obtain the information regarding the predefined logic regions from the OS 210 and/or the display content based driver 146 and present it to the user for selection.

If the window warping mode is selected, the display content based warp UI 142 may further include a destination size selection data 1412 that allows the user to select the desired destination size after the movement of a window. In this example, multiple selection data that represent various destination size options are provided to the user.

Any other suitable selection data may also be provided by the display content based warp UI 142 to receive additional configuration information 200 for the display content based warp operation if desired. For example, transition effect selection data may be provided to allow the user to select a desired transition effect for the display content based warp operation. All the configuration information 200 received from each selection data of the display content based warp UI 142 is consolidated and saved. The user may create a new configuration file 202 or select and modify an existing configuration file 202 via configuration file selection data 1414. For example, the configuration file selection data 1414 may provide selection data 1416 that allows the user to select the directory of the configuration file 202. It is understood that the configuration file selection data 1414 may be omitted, and the configuration information 200 may be automatically stored in an OS database (e.g., Windows Registry) by the display content based warp UI 142.

Also, the display content based UI, display content based service, and display content based driver described herein may be implemented as software programs stored on a computer readable storage medium such as but not limited to CDROM, RAM, other forms of ROM, hard drives, distributed memory, etc., in combination with processors. As such, software programs may be stored on computer readable storage medium. The computer readable storage medium stores instructions executable by one or more processors that causes the one or more processors to perform operations described herein.

Among other advantages, for example, the apparatus provides the ability to quickly move one or more GUI objects to a desired location across multiple displays or within a single high resolution and/or large size display with fewer user interactions and higher movement precision. Instead of specifying X and Y coordinate of the destination position or following a limited number of predefined destination positions, user can select the destination position of the GUI object based on particular display content, which is more intuitive and user-friendly, thereby improving user experience in the GUI environment. Furthermore the apparatus can obtain information associated with the display content directly from the display content based warp driver in addition to the OS and thus, can be applied to display modes that involve “OS invisible” displays such as the SLS display mode (also known as the span mode or stretch mode). Moreover, as a generic approach, the apparatus performs warp operation on pointing objects, window or any other suitable GUI object or combination thereof. Accordingly, the proposed techniques can improve user experience in GUI environment by providing a more intuitive and user-friendly way to control movement of different GUI objects in various display modes. Other advantages will be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. An apparatus for providing multi-mode warping of graphical user interface objects comprising:
logic operative to provide a display content based warp user interface that allows selection of a warping mode from at least a pointing object warping mode that controls movement of at least one pointing object from a start position of the pointing object to a destination position of the pointing object by applying a display content based warp operation to the pointing object, and a window warping mode that controls movement of at least one window from a start position of the window to a destination position of the window by applying a display content based warp operation to the window,
wherein the destination positions of the pointing object and window are determined based on content identification information associated with display content.

2. The apparatus of claim 1, wherein the display content based warp user interface is operative to provide configuration information for the display content based warp operation; and wherein the logic is further operative to affect the selected warping mode based on the configuration information.

3. The apparatus of claim 2, wherein the display content based warp user interface comprises warping mode selection data operative to provide selection of the warping mode from at least the pointing object warping mode and the window warping mode as part of the configuration information.

4. The apparatus of claim 2, wherein the display content based warp user interface comprises display content selection data operative to provide selection of desired display content as part of the configuration information.

5. The apparatus of claim 2, wherein the display content based warp user interface comprises action selection data operative to provide selection of an action that triggers the display content based warp operation as part of the configuration information.

6. The apparatus of claim 2, wherein the display content based warp user interface comprises destination display selection data operative to provide selection of a destination display from a plurality of displays as part of the configuration information.

7. The apparatus of claim 2, wherein the display content based warp user interface comprises destination size selection data operative to provide selection of a destination size of the window in the window warping mode as part of the configuration information.

8. The apparatus of claim 1, wherein the display content based warp user interface is a graphical user interface; and wherein the logic is further operative to cause presentation of the display content based warp user interface on a display.

9. A computer readable storage medium comprising executable instructions that when executed by one or more processors causes the one or more processors to:
provide a display content based warp user interface that allows selection of a warping mode from at least a pointing object warping mode that controls movement of at least one pointing object from a start position of the pointing object to a destination position of the pointing object by applying a display content based warp operation to the pointing object, and a window warping mode that controls movement of at least one window from a start position of the window to a destination position of the window by applying a display content based warp operation to the window,
wherein the destination positions of the pointing object and window are determined based on content identification information associated with display content.

10. The computer readable storage medium of claim 9, wherein the display content based warp user interface is operative to provide configuration information for the display content based warp operation, the computer readable storage medium further comprising executable instructions that when executed by one or more processors causes the one or more processors to affect the selected warping mode based on the configuration information.

11. The computer readable storage medium of claim 10, wherein the display content based warp user interface comprises warping mode selection data operative to provide selection of the warping mode from at least the pointing object warping mode and the window warping mode as part of the configuration information.

12. The computer readable storage medium of claim 10, wherein the display content based warp user interface comprises display content selection data operative to provide selection of desired display content as part of the configuration information.

13. The computer readable storage medium of claim 10, wherein the display content based warp user interface comprises action selection data operative to provide selection of an action that triggers the display content based warp operation as part of the configuration information.

14. The computer readable storage medium of claim 10, wherein the display content based warp user interface comprises destination display selection data operative to provide selection of a destination display from a plurality of displays as part of the configuration information.

15. The computer readable storage medium of claim 10, wherein the display content based warp user interface comprises destination size selection data operative to provide selection of a destination size of the window in the window warping mode as part of the configuration information.

16. An apparatus for providing multi-mode warping of graphical user interface objects comprising logic operative to:
select a warping mode from at least a pointing object warping mode and a window warping mode;
determine a destination position of at least one graphical user interface object based on content identification information associated with display content;
in the pointing object warping mode, control movement of at least one pointing object from a start position to the destination position by applying a display content based warp operation to the pointing object; and
in the window warping mode, control movement of at least one window from a start position to the destination position by applying a display content based warp operation to the window.

17. The apparatus of claim 16 further comprising a plurality of displays including at least a first display and a second display, wherein the start position is for a position displayed on the first display, and the destination position is for a position displayed on the second display.

18. The apparatus of claim 17, wherein the logic comprises:
a display content based warp driver operative to provide content identification information associated with the display content; and
a display content based warp service operative to:
determine a destination display of the destination position from the plurality of displays;
obtain, from the display content based warp driver, the content identification information associated with the display content on the destination display; and
determine the destination position based on the obtained content identification information.

19. The apparatus of claim 16, wherein the logic further comprises a display content based warp user interface operative to:
receive configuration information for the display content based warp operation; and
store the configuration information in a configuration file.

20. The apparatus of claim 19 further comprising an input device operative to receive an action indicating movement of the graphic user interface object, wherein the display content based warp service is further operative to determine the display content based warp operation corresponding to the action based on configuration information stored in the configuration file.

21. The apparatus of claim 20, wherein the input device is further operative to receive supplemental configuration information for the display content based warp operation, the supplemental configuration information being associated with the action; and wherein the display content based warp service is further operative to determine the corresponding display content based warp operation based on the configuration information and the supplemental configuration information associated with the action.

22. The apparatus of claim 17, wherein, in the window warping mode, the display content based warp service is further operative to:
determine the destination position and a destination size of the window based on content attribute information associated with the display content; and
control adjustment of the size of the window to the destination size on the destination position.

23. The apparatus of claim 22, wherein the display content based warp driver is further operative to provide content attribute information associated with the display content; and wherein the display content based warp service is further operative to:
obtain, from the display content based warp driver, the content attribute information associated with the display content; and
determine the destination position and the destination size of the window based on the obtained content attribute information.
